(19) United States
(12) Patent Application Publication
(10) Pub. No.: US 2014/0030574 A1
(43) Pub. Date: Jan. 30, 2014

(54) CAR BATTERY WITH WATERPROOFNESS, FIREPROOFNESS, SHOCKPROOFNESS AND EXPLOSION-PROOFNESS AND A MANUFACTURING METHOD THEREOF

(71) Applicant: JIA-YUAN LEE, Taipei (TW)

(72) Inventor: JIA-YUAN LEE, Taipei (TW)

(21) Appl. No.: 13/558,345

(22) Filed: Jul. 26, 2012

(51) Int. Cl. H01M 2/06; H01M 6/00; H01M 10/50

(52) U.S. Cl. 429/120; 429/157; 29/623.1

(57) ABSTRACT

A car battery with waterproofness, fireproothess, shockproofness and explosion-proofness is provided, which includes a plurality of Li—Fe batteries, at least one carrier, an electrical module and a package. The Li—Fe batteries are installed in the carrier, and the electrical module is connected to each of the Li—Fe batteries. The package wraps the Li—Fe batteries, the at least one carrier and the electrical module in a vacuum environment. A method for manufacturing a car battery is also provided. As such, the package is made of thermally conductive plastic, such that the car battery can be waterproof, fireproof, shockproof, and explosion-proof, and assured to provide good safety and stability when being used.

### BACKGROUND OF THE INVENTION

1. Field of the Invention

The present invention relates to a car battery, especially to a car battery with waterproofness, fireproofness, shockproofness and explosion-proofness and a manufacturing method thereof.

2. Description of the Related Art

Conventionally, Li—Fe batteries have positive electrodes made by lithium iron phosphate (LiFePO₄). The Li—Fe batteries are resistant to heat, structurally stable and non-polluting as well as having long cycle lives, small volumes and high discharge power. In particular, the Li—Fe batteries have abilities to discharge with instantaneous large current (150 Amp in 20 microseconds) and working voltage higher than 0.7 Volt, such that the car having the Li—Fe batteries can save fuels and achieve the performance of spontaneous actuation. However, the Li—Fe battery has cost high, and the large difference between the initial and terminal power limits the utilization.

Generally, such Li—Fe batteries are used mostly in series connection to form a 24-Volt power system. For series Li—Fe batteries power systems, if the number of the batteries increases, the number of the cases and modules for assembling the batteries also increases that make high costs of manufacturing molds. In addition, the dreadful operating environment for car batteries is not only the awfully small spaces of the batteries in the car to dissipate heat, but also operated under unsteady condition. Besides the regular modes in common, there are different specifications for cars, such as Japanese Industrial Standard (JIS), Battery Council International (BCI), Deutsches Institut für Normung (DIN) and the like, and the locations of the electrical pile head of the three specifications are also different such as the SL type, the SR type and the SIDE type, so that the conventional car batteries are not proper for large-scale manufactures, and keeping high costs. The consumers usually concern if the batteries are suitable for various kinds of cars, since the Li—Fe batteries having long cycle lives may be just a waste.

Currently, there are two kinds of car batteries, which are the two configurations in cars of single Li—Fe car battery and Li—Fe batteries combined with Lead-acid batteries. The car batteries described above are including Li—Fe batteries put in a plastic box with several divisions, and each of the division accommodates the batteries respectively. Alternatively, the Li—Fe batteries are wrapped in a bracket and beneficial to subsequent series connections. Nevertheless, most of the plastic boxs or the brackets are designed to be waterproof and shockproof, which become less effective with time. The car batteries are regarded still unstable without fireproofness and explosion-proofness.

### SUMMARY OF THE INVENTION

In view of the description above, the primary objective of the present invention is to provide a car battery, which comprises a plurality of Li—Fe batteries, at least one carrier and a package used for fixing the Li—Fe batteries. Within addition to the waterproofness, fireproofness, shockproofness and explosion-proofness of the package, it can also dissipate heat from the Li—Fe batteries, and thus improve safety and stability when in use.

To achieve the primary objective, a car battery with waterproofness, fireproofness, shockproofness and explosion-proofness in accordance with the present invention comprises a plurality of Li—Fe batteries, wherein each of the Li—Fe batteries has two ends, and the two ends respectively are a positive electrode and a negative electrode; at least one carrier, wherein each of the at least one carrier has an upper surface, a lower surface, and a plurality of chambers, wherein each of the chambers is placed with each of the Li—Fe batteries, and the positive electrodes and the negative electrodes are respectively exposed to the upper surface and lower surface of the carrier; an electrical module has a plurality of positive electrode screws, at least one positive electrode connection sheet is connected to the positive electrode of the Li—Fe battery respectively by the positive electrode screws; a plurality of negative electrode screws, at least one negative electrode connection sheet is connected to the negative electrode of the Li—Fe battery respectively by the negative electrode screws; a pair of connection wires are respectively connected to the electrode connection sheet and the negative electrode connection sheet; a connector is installed on one end of the pair of connection wires and used for outputting electricity of the Li—Fe batteries; a package is wrapping the Li—Fe batteries, the at least one carrier and the electrical module and the package is formed a dense protective structure by a packaging process in a vacuum environment, wherein the connector and the pair of connection wires are protruding from the package.

Preferably, the carrier has a groove and a protrusion, and the groove and the protrusion are used for connecting two adjacent carriers. The carrier is made of thermally conductive foam or thermally conductive plastic, which is low cost and easy to be designed for a variety of series connection thereof.

Preferably, the package is made of thermally conductive plastic and used for dissipating heat from the Li—Fe batteries.

In one embodiment, the car battery of the invention further comprises an outer shell wrapping the package, and the outer shell is made of metal or plastic, such that the car battery can be well-protected by the outer shell.

In one embodiment, the car battery of the invention further comprises a plurality of insulating sheaths, and the insulating sheaths respectively wrap the positive electrode screws and are mounted thereon, such that the insulating sheaths can be anti-flashover during the discharging of the car batteries.

The secondary objective of the present invention is to provide a method for manufacturing the car battery with waterproofness, fireproofness, shockproofness and explosion-proofness of the invention. To achieve the secondary objective, the method in accordance with the invention comprises the steps: provide the plurality of Li—Fe batteries, the at least one carrier and the electrical module, wherein the carrier has the plurality of chambers; install each of the Li—Fe batteries in each of the chambers of the at carrier; electrically connect the positive electrode and the negative electrode of each of the Li—Fe batteries by the electrical module; provide the vacuum environment and wrap the Li—Fe batteries, the at least one carrier and the electrical module in the vacuum environment by the package, letting the connector and the pair of connection wires protrude from the package, solidifying the package to finish the packaging process, and obtaining the car battery.

Preferably, the manufacturing method further comprises the step of wrapping the package by the outer shell after solidifying the package, to make the car battery well-protected.

Preferably, the package is solidified to form a cubic body under the conditions of room temperature and atmospheric pressure, such that the package is a dense protective structure and bubbles will not generate in the package.

### BRIEF DESCRIPTION OF THE DRAWINGS

FIG. 1 is an exploded view of a first embodiment of a car battery of the present invention.

FIG. 2 is a perspective view of a first embodiment of a car battery of the present invention.

FIG. 3 is a flow chart of a method for manufacturing a first embodiment of a car battery of the present invention.

FIG. 4 is a perspective view in S01 of a method for manufacturing a first embodiment of a car battery of the present invention.

FIG. 5 is a perspective view in S02 of a method for manufacturing a first embodiment of a car battery of the present invention.

FIG. 6 is a perspective view in S03 of a method for manufacturing a first embodiment of a car battery of the present invention.

FIG. 7 is a perspective view in S04 and S05 of a method for manufacturing a first embodiment of a car battery of the present invention.

FIG. 8 is a perspective view in S06 of a method for manufacturing a first embodiment of a car battery of the present invention.

FIG. 9 is a perspective view of a method for manufacturing a second embodiment of a car battery of the present invention.

FIG. 10 is a perspective view of a method for manufacturing a third embodiment of a car battery of the present invention.

### DETAILED DESCRIPTION OF THE PREFERRED EMBODIMENTS

The technical contents of the present invention will become apparent with the detailed description of preferred embodiments and the illustration of related drawings as follows.

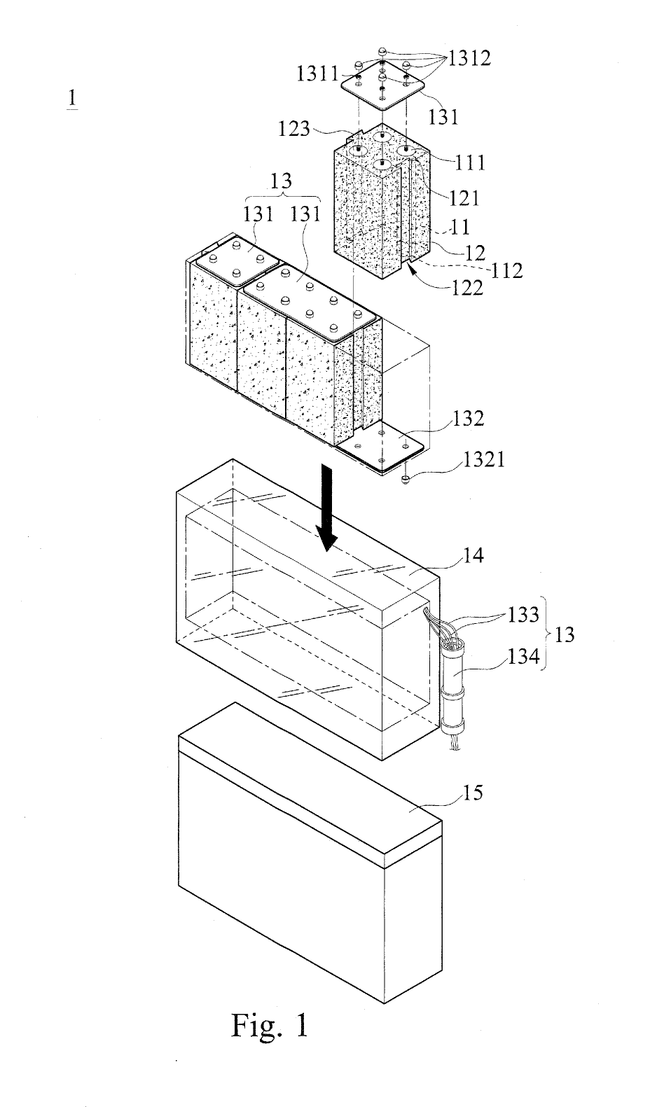

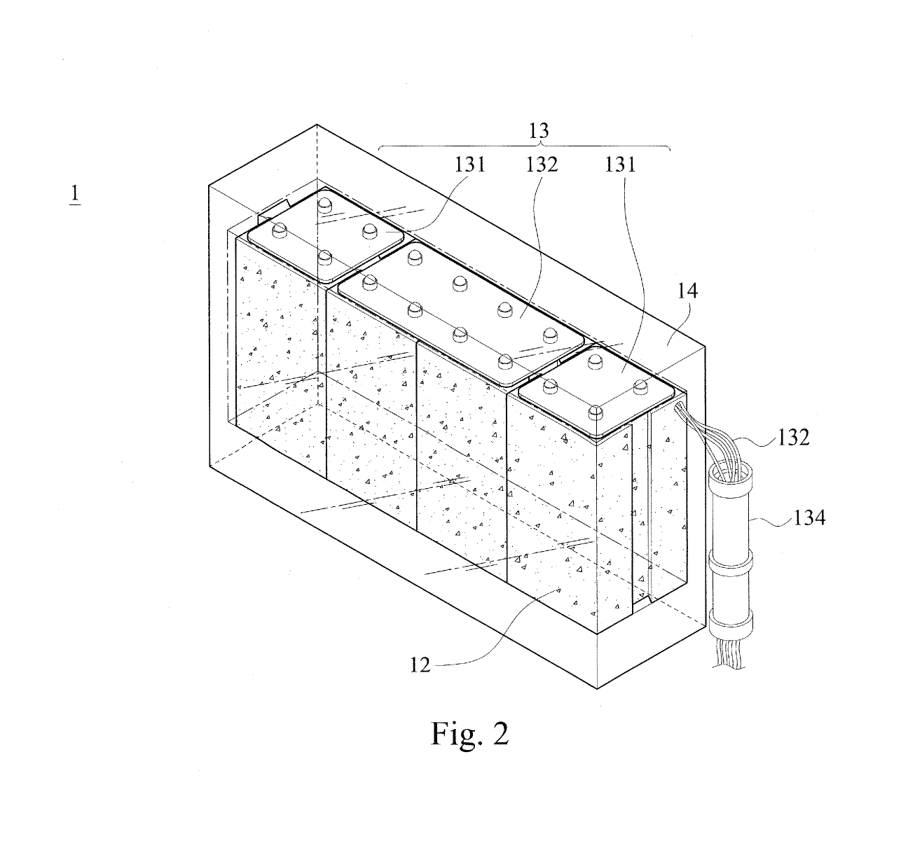

With reference to FIGS. 1 and 2 for an exploded view and a perspective view of the invention, a car battery 1 in accordance with the invention comprises a plurality of Li—Fe batteries 11, at least one carrier 12, an electrical module 13 and a package 14. After assembling the elements above, the car battery 1 with waterproofness, fireproofness, shockproofness and explosion-proofness can be achieved.

In a preferred embodiment, each of the Li—Fe batteries 11 has two ends, and the two ends respectively are a positive electrode 111 and a negative electrode 112.

Each of the carriers 12 is a rectangular block structure made of thermally conductive foam or thermally conductive plastic. Each of the carriers 12 has an upper surface, a lower surface and a plurality of chambers 121. Each of the chambers 121 is a through hole running through the upper surface and lower surface and used for placing each of the Li—Fe battery 11, such that the positive electrode 111 and the negative electrode 112 of each of the Li—Fe battery 11 are respectively exposed to the upper surface and lower surface of the carrier 12. In one embodiment of the present invention, four Li—Fe batteries 11 mounted in each of the carriers 12 form a cell therein. Furthermore, each of the carriers 12 has a groove 122 and a protrusion 123 on two opposite sides thereof, and the groove 122 and the protrusion 123 are used for connecting two adjacent carriers 12 to provide better convenience and stability when assembling the carriers together.

The electrical module 13 has a plurality of positive electrode connection sheets 131, a plurality of negative electrode connection sheets 132, and a pair of connection wires 133, a connector 134, a plurality of positive electrode screws 1311, and a plurality of negative electrode screws 1321. The positive electrode connection sheets 131 and the negative electrode connection sheets 132 are formed in sheet structures made of conductive metal, and the shape, size of the sheet structures are cut out in accordance with the actual needs, not limited to the rectangular shape. The positive electrode connection sheets 131 are connected to the positive electrodes 111 of the Li—Fe batteries 11 respectively by the positive electrode screws 1311. Therefore, each of the carriers 12 mounted with four Li—Fe batteries 11 forms the cell, wherein four positive electrodes 111 are parallel connected by the positive electrode connection sheets 131. Also, with the negative electrode screws 1321, the negative electrode connection sheets 132 are connected respectively to the negative electrodes 111 of the Li—Fe batteries 11. Therefore, in the cell, the negative electrodes 111 are parallel connected by the negative electrode connection sheets 132. The pair of connection wires 133 are connected to the positive electrode connection sheets 131 and the negative electrode connection sheets 132 respectively to form a series connection. The connector 134 is installed on one end of the pair of connection wires 133 and used for exporting electricity of the Li—Fe batteries 11. For further improve the safety of the car battery 1, the car battery 1 of the invention further comprises a plurality of insulating sheaths 1312 respectively covering and being mounted on the positive electrode screws 1311, such that the car battery 1 can be anti-flashover during discharging.

The package 14 is made of thermally conductive plastic, and used for wrapping the Li—Fe batteries 11, the carriers 12 and the electrical module 13. The pair of connection wires 133 and the connector 134 are protruding from the package 14. The package 14 is made a dense protective structure by packaging process in a vacuum environment. Due to the package 14 is thermally conductive plastic itself, the package can dissipate the heat from the Li—Fe batteries 11 during operation.

Due to the package 14 is soft even after solidified, the car battery 1 further comprises an outer shell 15 wrapping the package 14. The shape and size of the outer shell 15 are corresponding to the package 14, and the outer shell 15 is made of metal or plastic, such that the car battery 1 can be well-protected.

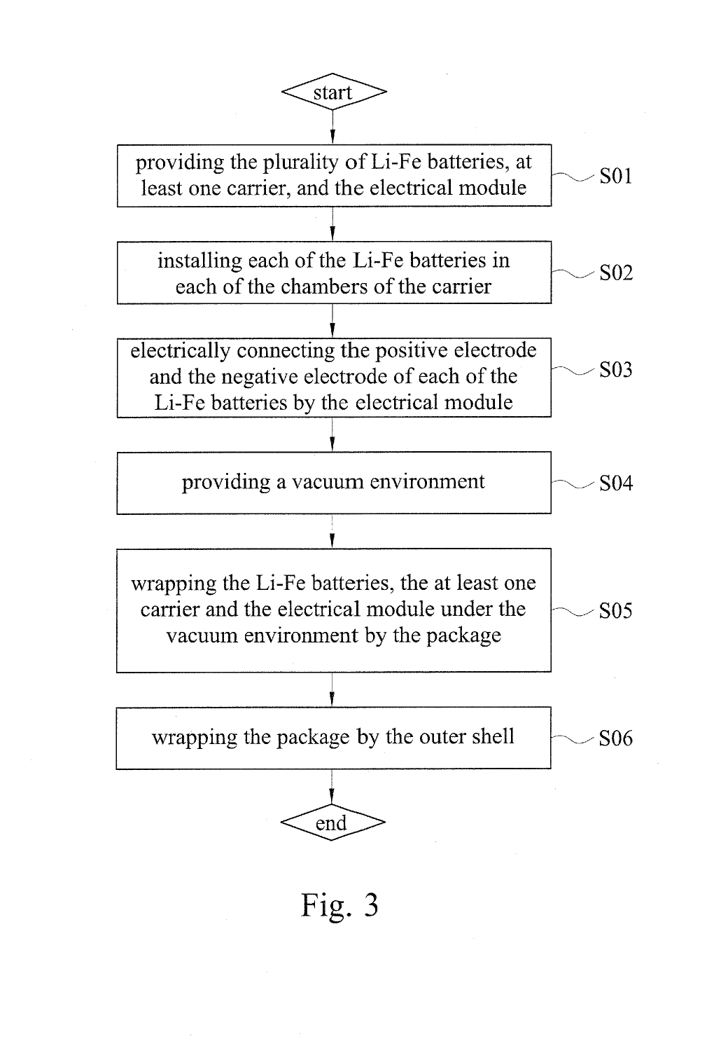

With reference to FIGS. 3 to 8 for a flow chart and perspective views of a method for manufacturing the car battery 1 in accordance with the first embodiment of the present invention. As shown in the FIGS, The method for manufacturing the car battery 1 of the invention comprises steps of:

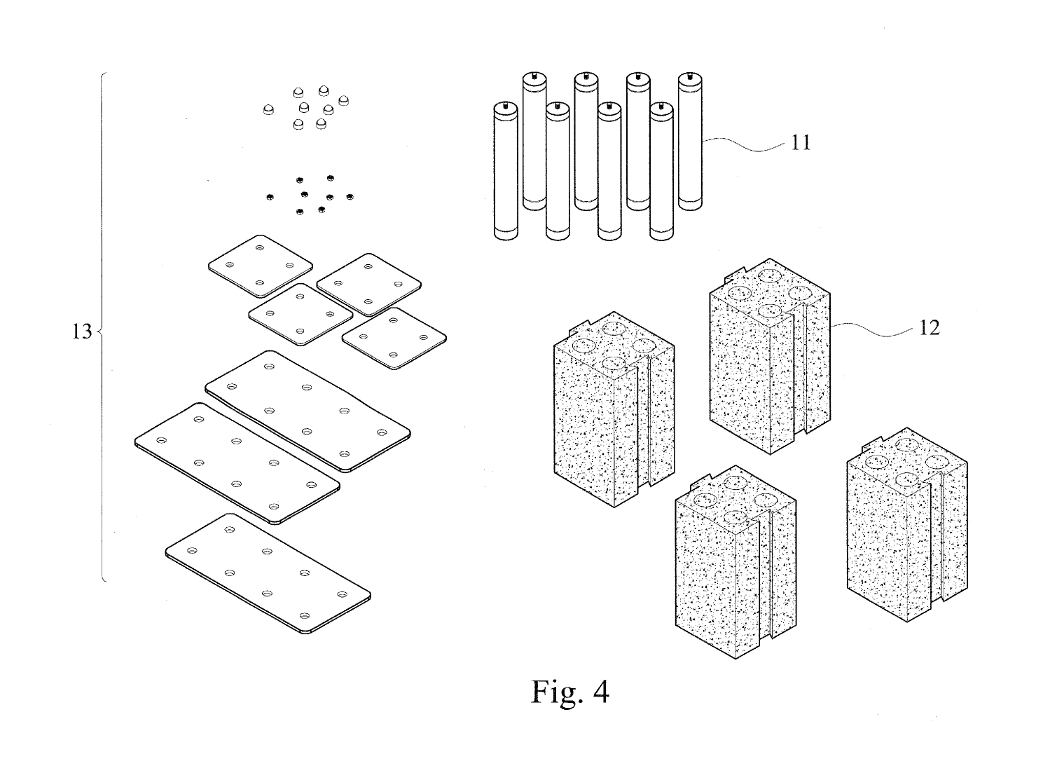

S01: Providing the plurality of Li—Fe batteries 11, at least one carrier 12, and the electrical module 13. As shown in FIG. 4, the plurality of Li—Fe batteries 11, at least one carrier 12, and the electrical module 13 are unassembled.

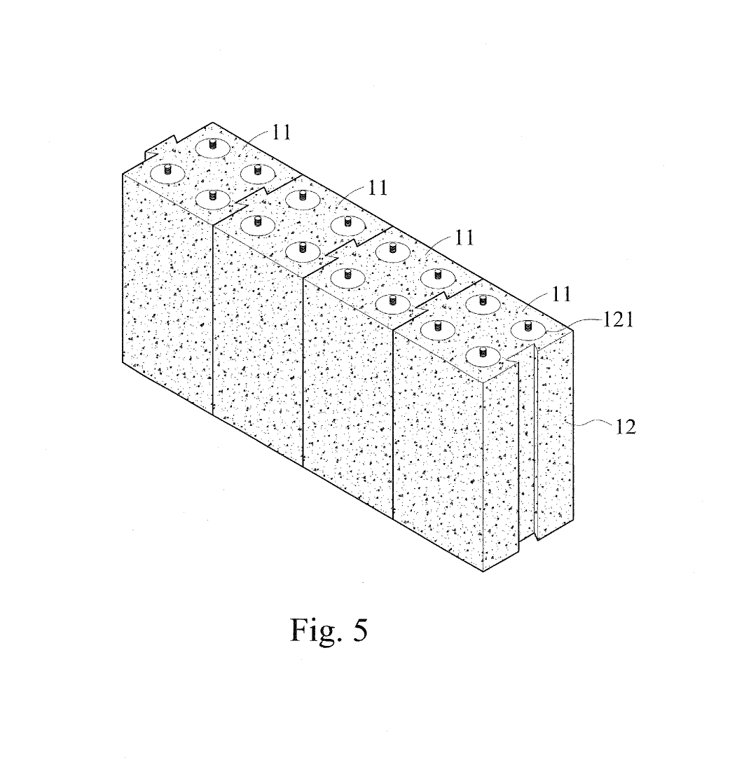

S02: installing each of the Li—Fe batteries 11 in each of the chambers 121 of the carrier 12. As shown in FIG. 5, each of Li—Fe batteries 11 is inserted successively to each of the chambers 121 to form the cell. In each of the cells, due to the structure and the material of the carrier 12, the Li—Fe batteries 11 are fixed and supported therein.

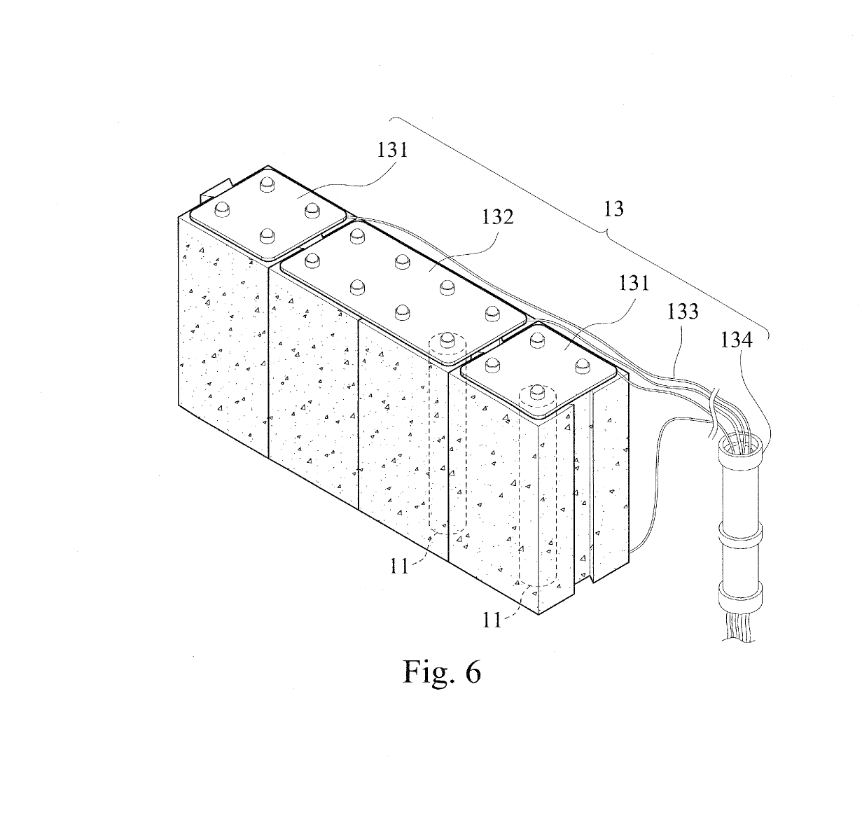

S03: electrically connecting the positive electrode 111 and the negative electrode 112 of each of the Li—Fe batteries 11 by the electrical module 13. As shown in FIG. 6, the plurality of positive electrode connection sheets 131 are respectively connected to the positive electrodes 111 of the Li—Fe batteries 11. The plurality of negative electrode connection sheets 132 respectively are connected to the negative electrodes 112 of the Li—Fe batteries 11. The pair of connection wires 133 are respectively connected the plurality of positive electrode connection sheets 131 and the plurality of negative electrode connection sheets 132, and the connector 134 is connected to one end of the pair of connection wires 133.

S04: providing a vacuum environment.

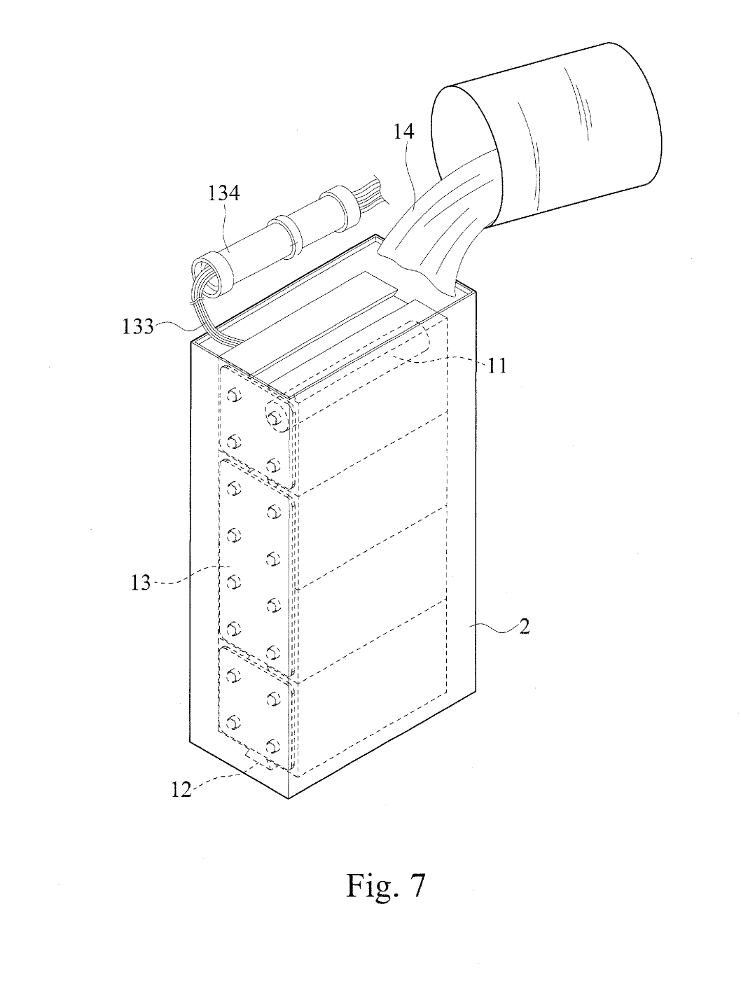

S05: wrapping the Li—Fe batteries 11, the at least one carrier 12 and the electrical module 13 under the vacuum environment by the package 14, letting the connector 134 and the pair of connection wires 133 protrude from the package 14, solidifying the package 14 to finish the packaging process, and obtaining the car battery 1. As shown in FIG. 7, a mold 2 is provided, and the Li—Fe batteries 11, the carriers 12 and the electrical module are placed therein. The pair of connection wires 133 and the connector 134 are protruding from the mold 2. The package 14 is melted and injected into the mold 2, and then the package 14 is solidified under room temperature and atmospheric pressure and obtained a rectangular block structure in accordance with the mold 2.

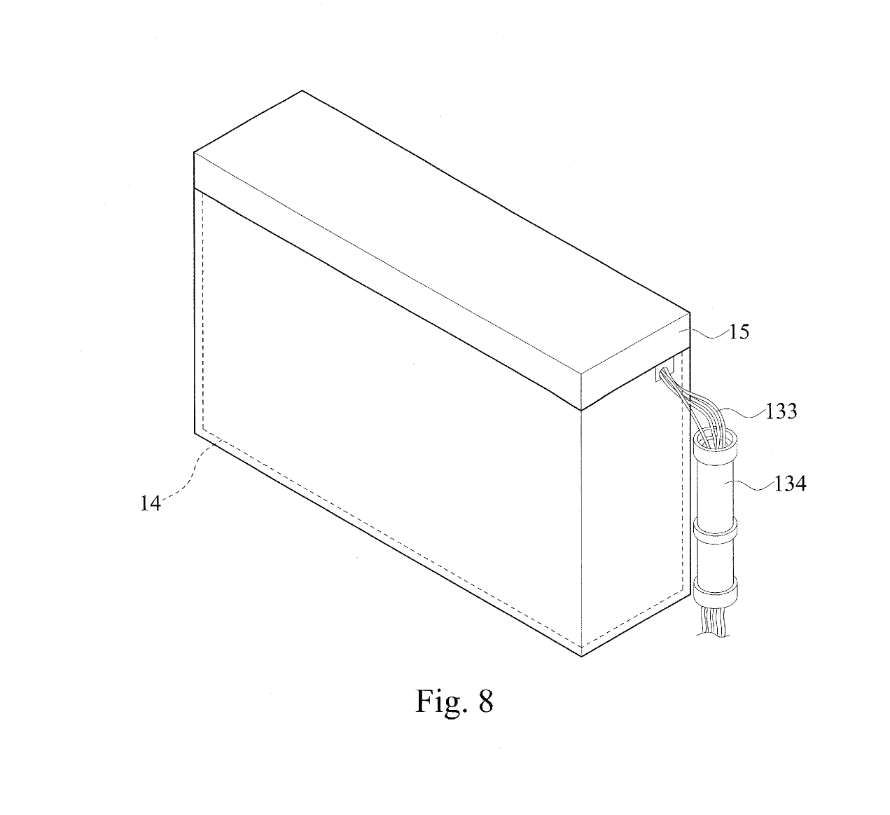

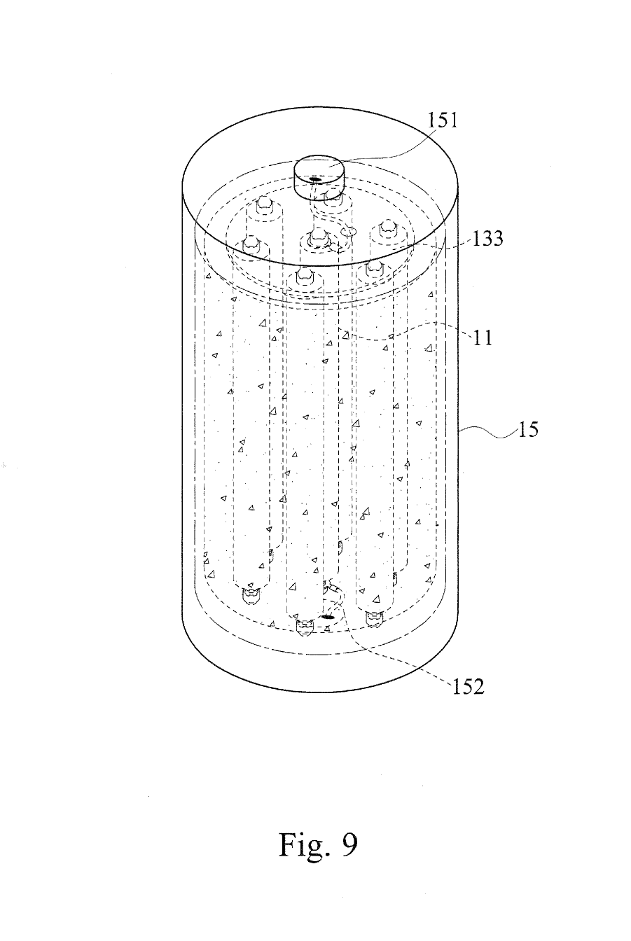

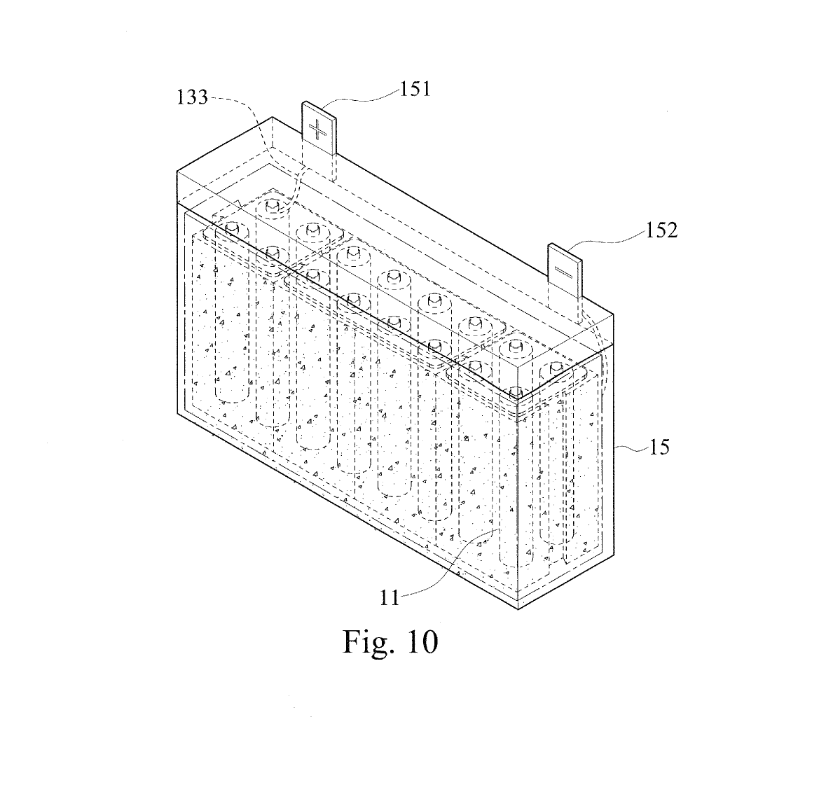

S06: after the packaging process, wrapping the package 14 by the outer shell 15. As shown in FIG. 8, the shape and size of the outer shell 15 is corresponding to the package 14 for wrapping the package 14 completely. The connector 134 and the pair of connection wires 133 are protruding from the outer shell 15. As such, wrapping the package 14 by an outer shell 15 provides better protection for the car battery 1 and easier transportation. With reference to FIGS. 9 and 10 for perspective views of a method for manufacturing another two embodiments of a car battery 1 of the present invention, the outer shell 15 has a positive electrode part 151 and a negative electrode part 152. The positive electrode part 151 and the negative electrode part 152 are respectively connected to the pair of connection wires 133, to be electrically connected to the Li-Fe batteries 11. As shown in FIG. 9, the outer shell 15 can be cylinder-shaped like a traditional battery. The positive electrode part 151 is on a top of the outer shell 15, and the negative electrode part 152 is on a bottom of the outer shell 15. The car battery 1 can be installed in a battery groove previously provided (not shown), like traditional batteries. Additionally, the car battery 1 can be installed in a special charger (not shown) for charging as traditional batteries by intuitive operation, and thus the convenience of the car battery 1 is improved. Alternatively, as shown in FIG. 10, the outer shell 15 can be cubic-shaped like another kind of traditional batteries. The positive electrode part 151 and the negative electrode part 152 are on the top of the outer shell 15. The positive electrode part 151 and the negative electrode part 152 are respectively two iron plates for electrically connected to positive electrodes 151 and negative electrodes 152. Accordingly, the carriers 12 and the package 14 provide support and protection for the Li-Fe batteries 11. Due to the package 14 made of thermally conductive plastic is soft and flexible, and the packaging process is performed in a vacuum environment, such that the car battery 1 of the invention can be waterproof, fireproof, shockproof and explosion-proof with the flexibleness. Furthermore, the carriers 12 and the package 14 are made of thermally conductive foam or thermally conductive plastic to be used for dissipating the heat from the Li—Fe batteries 11 and thus improve the safety and stability during operation, as well as prolonging the lifetime of the car battery 1.

What is claimed is:

1. A car battery with waterproofness, fireproofness, shockproofness, and explosion-proofness, comprising
a plurality of Li—Fe batteries, wherein each of the Li—Fe batteries has two ends, and the two ends respectively are a positive electrode and a negative electrode;
at least one carrier, wherein each of the at least one carrier has:
an upper surface;
a lower surface; and
a plurality of chambers, wherein each of the chambers for placing each of the Li—Fe batteries, and the positive electrodes and the negative electrodes are respectively exposed to the upper surface and the lower surface of the at least one carrier;
an electrical module having:
a plurality of positive electrode screws;
at least one positive electrode connection sheet connected to the positive electrodes of the Li—Fe batteries respectively by the positive electrode screws;
a plurality of negative electrode screws;
at least one negative electrode connection sheet connected to the negative electrode of the Li—Fe batteries respectively by the negative electrode screws;
a pair of connection wires respectively connected to the positive electrode connection sheet and the negative electrode connection sheet,; and
a connector, installed on one end of the pair of connection wires and used for outputting electricity of the Li—Fe batteries ; and
a package wrapping the Li—Fe batteries, the carrier and the electrical module and being formed in a dense protective structure through a packaging process in a vacuum environment, and the connector and the pair of connection wires are protruding from the package.

2. The car battery of claim 1, wherein the carrier has a groove and a protrusion, and the groove and the protrusion are used for connecting two adjacent carriers.

3. The car battery of claim 2, wherein the carrier is made of thermally conductive foam or thermally conductive plastic.

4. The car battery of claim 1, wherein the carrier is made of thermally conductive foam or thermally conductive plastic.

5. The car battery of claim 1, wherein the package is made of thermally conductive plastic and used for dissipating the heat from the Li—Fe batteries.

6. The car battery of claim 1, further comprising an outer shell wrapping the package.

7. The car battery of claim 6, wherein the outer shell is made of metal or plastic.

8. The car battery of claim 1, further comprising a plurality of insulating sheaths respectively wrapping and being mounted on the positive electrode screws.

9. A method for manufacturing the car battery of claim 1, comprising steps of:
providing the plurality of Li—Fe batteries, the at least one carrier and the electrical module, wherein the at least one carrier has the plurality of chambers;
installing each of the Li—Fe batteries in each of the chambers of the carrier;
electrically connecting the positive electrode and the negative electrode of each of the Li—Fe batteries by the electrical module;
providing the vacuum environment; and
wrapping the Li—Fe batteries, the at least one carrier and the electrical module in the vacuum environmente by the package, letting the connector and the pair of connection wires protrude from the package, solidifying the package to finish the packaging process, and obtaining the car battery.

10. The method of claim 9, further comprising the step of: wrapping the package by the outer shell after solidifying the package.

11. The method of claim 9, wherein the package is solidified to form a rectangular block structure under the conditions of room temperature and atmospheric pressure.
